(19) United States
(12) Patent Application Publication
(10) Pub. No.: US 2025/0236180 A1
(43) Pub. Date: Jul. 24, 2025

(54) CONTROL DEVICE AND METHOD FOR OPERATING A RECUPERATIVE BRAKE SYSTEM OF A VEHICLE

(71) Applicant: Robert Bosch GmbH, Stuttgart (DE)

(72) Inventors: Benedikt Friedrich, Stuttgart (DE); Manjunath Gubbi, Stuttgart (DE)

(21) Appl. No.: 18/855,412

(22) PCT Filed: Jun. 2, 2023
(86) PCT No.: PCT/EP2023/064870

§ 371 Date: Oct. 9, 2024

(30) Foreign Application Priority Data
Jun. 8, 2022 (DE) 10 2022 205 840.2

(51) Int. Cl. B60L 7/26

(52) U.S. Cl. CPC B60L 7/26

(57) ABSTRACT

A control device and method for a recuperative brake system of a vehicle. In the method, if a requested vehicle deceleration can only partially be produced using at least one electric motor, a differential pressure control is carried out in the wheel brake cylinders, including: defining a target differential pressure for first and second wheel brake cylinders, actuating at least one wheel inlet valve arranged upstream of the second wheel brake cylinders, using a current signal output to the wheel inlet valve taking into consideration the defined target differential pressure, and defining a target current strength of the current signal taking into consideration the defined target differential pressure. The target current strength of the current signal or the initial value of the target current strength is selected from a set of values including at least three current strength values, taking into consideration the defined target differential pressure.

### FIELD

The present invention relates to a control device for a recuperative brake system of a vehicle and to a recuperative brake system for a vehicle. The present invention also relates to a method for operating a recuperative brake system of a vehicle.

### BACKGROUND INFORMATION

FIGS. 1A and 1B show coordinate systems for explaining a conventional procedure for operating a recuperative brake system of a vehicle, known to the applicant as internal related art. The abscissa of the coordinate systems of FIGS. 1A and 1B is the time axis t in each case.

During a first braking process shown by means of the coordinate system in FIG. 1A, by actuating a brake actuating element of the brake system a driver of the vehicle requests a vehicle deceleration a, not equal to zero, starting at a time t0. In the conventional procedure, an operating state Φ of an electric motor of the brake system that can be operated in its recuperative mode Φᵣ is therefore switched from its inactive mode Φ₀ to its recuperative mode Φᵣ starting at time t0. Between times t0 and t1, the vehicle deceleration a not equal to zero requested by the driver can be brought about by means of the electric motor operated in its recuperative mode Φᵣ. A first target brake pressure P_{1target} to be set in first wheel brake cylinders of the brake system, which are assigned to a first axle of the vehicle, and a second target brake pressure P_{2target} to be set in second wheel brake cylinders of the brake system, which are assigned to a second axle of the vehicle, are therefore equal to zero between the times t0 and t1. In order to avoid a build-up of brake pressure in the first wheel brake cylinder and in the second wheel brake cylinder per brake circuit between times t0 and t1, second wheel outlet valves arranged downstream of the second wheel brake cylinders are switched to their open state between times t0 and t1, although this is not shown graphically in the coordinate system in FIG. 1A. However, it can be seen from the coordinate system in FIG. 1A that at the same time as the first wheel inlet valves upstream of the first wheel brake cylinders are switched open, the second wheel inlet valves upstream of the second wheel brake cylinders are also switched to their open state between times t0 and t1. A current strength I of a current signal that is output to the open second wheel inlet valves, which are open when currentless, is also shown in the coordinate system of FIG. 1A. Between the times t0 and t1, a first actual brake pressure p₁ present in the first wheel brake cylinders and a second actual brake pressure p₂ present in the second wheel brake cylinders are therefore (almost) equal to zero.

Beginning from time t1, the vehicle deceleration a requested by the driver can no longer be brought about exclusively by means of the electric motor operated in its recuperative mode Φᵣ. However, the requested vehicle deceleration a between times t1 and t2 can be brought about by means of the electric motor operated in its recuperative mode Φᵣ and by means of the first wheel brake cylinders assigned to the first axle of the vehicle. For this reason, the first target brake pressure p_{1target} to be set in the first wheel brake cylinders is defined to be not equal to zero between times t1 and t2, while the second target brake pressure p_{2target} to be set in the second wheel brake cylinders remains equal to zero between times t1 and t2. In addition, the first wheel outlet valves downstream of the first wheel brake cylinders are kept closed starting at time t1, while the second wheel outlet valves downstream of the second wheel brake cylinders continue to be controlled to be in their open state between times t1 and t2. By means of a differential pressure control executed by the second wheel inlet valves of the second wheel brake cylinders during a time interval T₀, an attempt is made to set the first actual brake pressure P₁ present in the first wheel brake cylinders in accordance with the defined first target brake pressure P_{1target}. According to the conventional procedure, the differential pressure control is carried out during the time interval T₀ by means of an alternation between providing an overcurrent to the second wheel inlet valves and providing an undercurrent to the second wheel inlet valves. In addition, by means of a non-zero pump speed n of at least one pump of the brake system, brake fluid can be pumped into the brake system from at least one low-pressure reservoir downstream of the first wheel outlet valves and the second wheel outlet valves. However, as indicated by the arrows 2, a “wavelike” pressure increase frequently occurs in the first wheel brake cylinders between times t1 and t2.

Starting from time t2, the electric motor operated in its recuperative mode Φᵣ and the first wheel brake cylinders assigned to the first axle of the vehicle are no longer sufficient to effect the requested vehicle deceleration a not equal to zero. For this reason, starting from time t2, the second target brake pressure p_{2target} to be set in the second wheel brake cylinders is also defined to be not equal to zero. The second wheel outlet valves downstream of the second wheel brake cylinders are kept closed from time t2 (like the first wheel outlet valves downstream of the first wheel brake cylinders). By means of the differential pressure control performed by the second wheel inlet valves, an attempt is also made to set the first actual brake pressure p₁ in the first wheel brake cylinders in accordance with the defined first target brake pressure p_{1target} and to set the second actual brake pressure p₂ in the second wheel brake cylinders in accordance with the second target brake pressure P_{2target}. According to the conventional procedure, this is also done by alternating between the provision of overcurrent to the second wheel inlet valves and of undercurrent to the second wheel inlet valves. The arrow 4 indicates that the pressure build-up in the second wheel brake cylinders caused in this way can undesirably trigger a strong drop in pressure in the first wheel brake cylinders.

In the second braking process shown in the coordinate system in FIG. 1B, the driver also requests a vehicle deceleration a not equal to zero starting at time t0 by actuating the brake actuating element, but this deceleration can still be achieved between times t0 and t1 by the electric motor operated in its recuperative mode Φᵣ. Compared to the first braking process explained above, however, during the second braking process the driver requests a significantly faster braking of the vehicle. During the second braking process, the vehicle deceleration a not equal to zero requested by the driver between times t0 and t1 can also only be achieved by means of the electric motor operated in its recuperative mode Φᵣ and by means of the first wheel brake cylinders of the first axle and, from time t2, only by means of the electric motor operated in its recuperative mode Φᵣ, by means of the first wheel brake cylinders, and by means of the second wheel brake cylinders of the second axle. The first target brake pressure p_{1target} to be set in the first wheel brake cylinders and the second target brake pressure p_{2target} to be set in the second wheel brake cylinders are defined accordingly. To set the first actual brake pressure p₁ in the first wheel brake cylinders and the second actual brake pressure p₂ in the second wheel brake cylinders, the differential pressure control is again carried out during the time interval T₀ by means of the second wheel outlet valves arranged upstream of the second wheel brake cylinders, by alternating between providing overcurrent to the second wheel inlet valves and undercurrent to the second wheel inlet valves in accordance with the conventional procedure. The arrow 6 indicates that, due to the requested faster braking of the vehicle, a considerable difference can occur between the first target brake pressure p_{1target} to be set in the first wheel brake cylinders and the first brake pressure p₁ actually built up in the first wheel brake cylinders, which can be perceived by the driver as an unpleasantly “soft” brake actuating element.

### SUMMARY

The present invention provides a control device for a recuperative brake system of a vehicle, a recuperative brake system for a vehicle, and a method for operating a recuperative brake system of a vehicle.

The present invention provides options for operating a recuperative brake system of a vehicle in such a way that the driver of the vehicle (essentially) does not perceive the masking processes carried out during actuation of a brake actuating element of the brake system. For example, alternating between braking the vehicle exclusively by means of at least one electric motor operated in its recuperative mode and braking the vehicle by means of the at least one electric motor and first wheel brake cylinders of the brake system assigned to a first axle of the vehicle does not cause, or causes only to a very small extent, an undesirable “wavelike” increase in pressure in the first wheel brake cylinders. Even changing between braking the vehicle by means of the at least one electric motor, by means of the first wheel brake cylinders, and by means of second wheel brake cylinders of the brake system assigned to a second axle of the vehicle, does not (as a rule) lead to a pressure drop in the first wheel brake cylinders or to a significant deviation of a first actual brake pressure in the first wheel brake cylinders from a first target brake pressure for the first wheel brake cylinders. The options provided by means of the present invention for operating a recuperative brake system of a vehicle thus provide improved driving and braking comfort for the driver of the vehicle. The present invention therefore contributes to encouraging drivers to purchase a vehicle equipped with a recuperative brake system, the driving of which is associated with lower energy consumption and possibly also with reduced pollutant emissions.

In an advantageous example embodiment of the control device of the present invention, the electronic device, in its differential pressure control mode, is designed and/or programmed to define the target current strength of the current signal or the initial value of the target current strength according to a specified continuous function with the set of values having the at least three current strength values, depending on the defined target differential pressure. This realizes a “smooth” control of the at least one (second) wheel inlet valve upstream of the second wheel brake cylinders by means of the embodiment of the control device described here. According to an example embodiment of the present invention, preferably, the electronic device is additionally designed and/or programmed, even after the start of its differential pressure control mode, to define an offset value for the target current strength of the current signal and to define the target current strength of the current signal as the sum of the initial value of the target current strength and the offset value, taking into account a deviation in each case of the at least one first actual brake pressure measured or estimated during a specified comparison time interval in the first wheel brake cylinders from the corresponding first target brake pressure to be set simultaneously in the first wheel brake cylinders. Component tolerances and/or aging effects on the recuperative brake system can be advantageously compensated for by means of the offset value defined in this way or the resulting target current strength.

As an advantageous development of the present invention, the electronic device can be additionally designed and/or programmed, after the start of its differential pressure control mode, to determine a time period during which the at least one measured or estimated first actual brake pressure in the first wheel brake cylinders deviates by at least a specified minimum pressure deviation from the first target brake pressure to be set simultaneously in the first wheel brake cylinders in each case, and, if the determined time period exceeds a specified time threshold value, to define the target current strength of the current signal for a specified or defined closing time such that the at least one wheel inlet valve is switched to its closed state by means of the current signal output thereto for the specified or defined closing time. In this way, the occurrence of a “soft” brake actuating element/brake pedal, as often occurs in the related art, can in particular be avoided by means of the control device embodiment described here.

As a further advantageous development of the present invention, the electronic device can also be designed and/or programmed, at the beginning of its differential pressure control mode, to define the target differential pressure as the difference between the specified or defined first target brake pressure to be set in the first wheel brake cylinders and the specified or defined second target brake pressure to be set in the second wheel brake cylinders, but, if the measured or estimated first actual brake pressure in the first wheel brake cylinders is less than the first target brake pressure to be set simultaneously in the first wheel brake cylinders by at least one specified limit deviation, the electronic device is designed and/or programmed to define, for a specified or defined transition time, the target differential pressure as the difference between the measured or estimated first actual brake pressure in the first wheel brake cylinders and the second target brake pressure to be set in the second wheel brake cylinders. The development of the control device described here can thus advantageously react to a significant deviation of the first actual brake pressure from the first target brake pressure in order to prevent the occurrence of an equal/corresponding deviation of the second actual brake pressure in the second wheel brake cylinders from the second target brake pressure to be set in the second wheel brake cylinders.

The advantages explained above are also ensured in a recuperative brake system for a vehicle having such a control device, the first wheel brake cylinders, which are assigned to a first axle of the vehicle, the second wheel brake cylinders, which are assigned to a second axle of the vehicle, and the at least one wheel inlet valve upstream of the second wheel brake cylinders.

Furthermore, carrying out a corresponding method for operating a recuperative brake system of a vehicle also provides the advantages explained above. It is expressly pointed out that the method for operating a recuperative brake system of a vehicle can also be further developed according to the example embodiments of the control device explained above.

### BRIEF DESCRIPTION OF THE DRAWINGS

Further features and advantages of the present invention will be explained in the following with reference to the figures.

FIGS. 1A and 1B show coordinate systems for explaining a conventional procedure for operating a recuperative brake system of a vehicle.

FIG. 2 shows a schematic representation of a recuperative brake system of a vehicle for explaining a mode of operation of an example embodiment of the control device of the present invention interacting therewith.

FIGS. 3A and 3B show coordinate systems for explaining an example embodiment of the method of the present invention for operating a recuperative brake system of a vehicle.

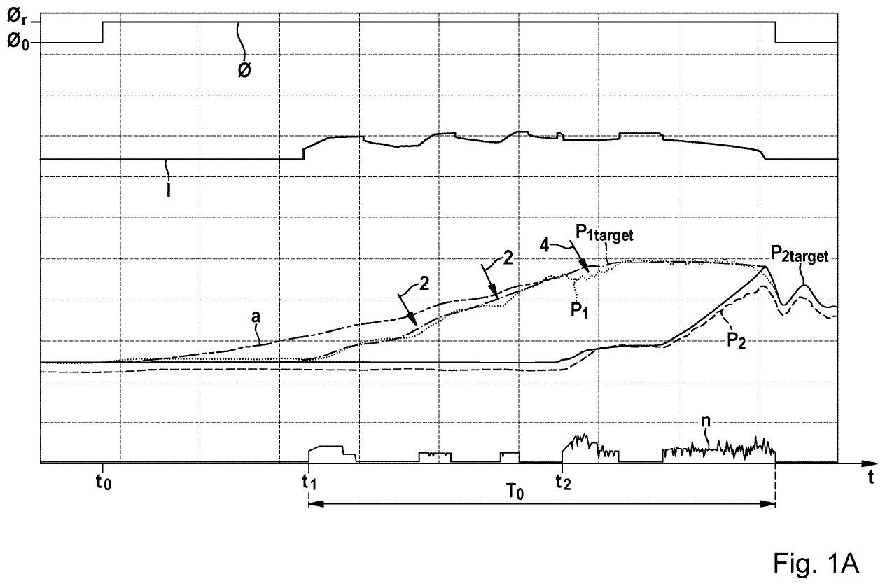

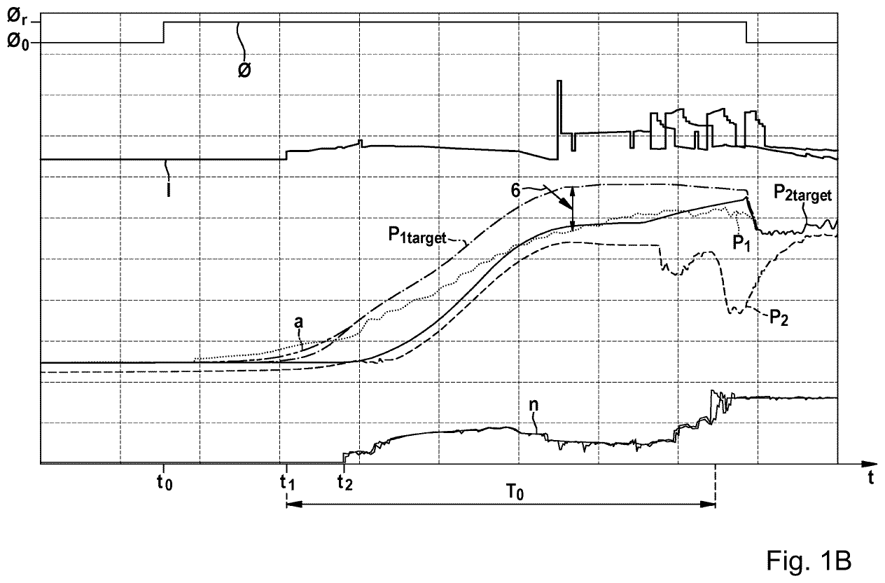

### DETAILED DESCRIPTION OF EXAMPLE EMBODIMENTS

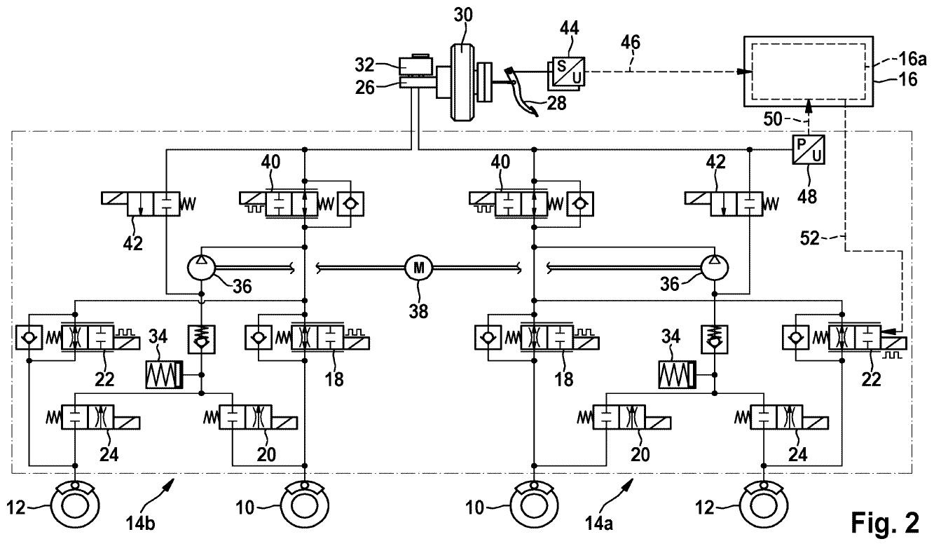

FIG. 2 shows a schematic representation of a recuperative brake system of a vehicle for explaining a mode of operation of an embodiment of the control device interacting therewith.

The recuperative brake system shown schematically in FIG. 2 has first wheel brake cylinders 10 and second wheel brake cylinders 12, the first wheel brake cylinders 10 being assigned to a first axle of the vehicle equipped with the brake system and the second wheel brake cylinders 12 being assigned to a second axle of the vehicle. This can be understood as meaning that the first wheel brake cylinders 10 are mounted on the first axle and the second wheel brake cylinders 12 are mounted on the second axle of the vehicle. In the brake system in FIG. 2, an X-split brake circuit layout is implemented by way of example only, wherein a first wheel brake cylinder 10 and a second wheel brake cylinder 12 are each connected to one of the two brake circuits 14a and 14b. The first axle can for example be the front axle, while the second axle is the rear axle. Alternatively, however, the first axle can also be the rear axle and the second axle can be the front axle.

The brake system acting together with the control device 16 also comprises at least one first wheel inlet valve 18 arranged upstream of the first wheel brake cylinders 10, at least one first wheel outlet valve 20 arranged downstream of the first wheel brake cylinders 10, at least one second wheel inlet valve 22 arranged upstream of the second wheel brake cylinders 12 and at least one second wheel outlet valve 24 arranged downstream of the second wheel brake cylinders 12. For example, a first wheel inlet valve 18 and a first wheel outlet valve 20 can be connected to each of the first wheel brake cylinders 10, and a second wheel inlet valve and a second wheel outlet valve can be connected to each of the second wheel brake cylinders 12. Preferably, the brake circuits 14a and 14b are connected to a brake master cylinder 26, upstream of which a brake actuating element 28, such as a brake pedal 28, can be provided. Optionally, a brake booster 30 and/or a brake fluid reservoir 32 can also be hydraulically connected to the brake master cylinder 26.

Optionally, a reservoir 34, such as specifically a low-pressure reservoir 34, can be arranged downstream of the at least one first wheel outlet valve 20 and/or second wheel outlet valve 24 of each brake circuit 14a and 14b. It can also be advantageous if the brake circuits 14a and 14b have at least one pump 36 which can preferably be operated by means of a common pump motor 38 of the brake system. As further optional components, the brake circuits 14a and 14b of the brake system of FIG. 2 each have a changeover valve 40 and a high-pressure switching valve 42.

However, it is to be noted that the embodiment of the brake system shown in FIG. 2 is to be interpreted only as an example. Instead, with the control device 16 described below, any recuperative brake system can be used whose hydraulic system has at least the components 10, 12, and 18 to 24. In addition, the usability of the control device 16 or of the recuperative brake system interacting therewith is not limited to a specific type of the vehicle/motor vehicle equipped with the brake system.

The control device 16 has an electronic device 16a, which is designed and/or programmed to query or ascertain whether a requested vehicle deceleration can be brought about only partially by means of at least one electric motor (not shown) of the brake system or of the vehicle operated in its recuperative mode. The at least one electric motor can, for example, be an electric drive motor of the vehicle. The requested vehicle deceleration can for example be understood as a vehicle deceleration requested by a driver of the vehicle by means of actuation of the brake actuating element 28. In particular, at least one brake actuating element sensor 44, such as a rod travel sensor and/or a differential travel sensor, can be mounted on the brake system, which sensor outputs a sensor signal 46 corresponding to the actuation of the brake actuating element 28. Alternatively or additionally, the requested vehicle deceleration can also be requested by an automatic speed control system (not shown) of the vehicle, by means of a corresponding brake request signal.

If the sensor signal 46 of the brake actuating element sensor 44 and/or the brake request signal of the automatic speed control system are provided to the electronic device 16a, the electronic device 16a can be designed/programmed to control/activate the recuperative mode of the at least one electric motor. In this case, when the at least one electric motor is being controlled, the electronic device 16a (automatically) ascertains whether the requested vehicle deceleration can be effected exclusively by means of the at least one electric motor operated in its recuperative mode. Alternatively, however, the control of the at least one electric motor can also be carried out by a motor controller, which then controls/activates the recuperative mode of the at least one electric motor taking into account the at least one sensor signal 46 of the at least one brake actuating element sensor 44 and/or the brake request signal of the automatic speed control. In this case, the electronic device 16a recognizes, by querying/reading an information signal output by the motor controller to the electronic device 16a, that the requested vehicle deceleration cannot be brought about exclusively by means of the at least one electric motor operated in its recuperative mode.

If necessary, i.e. if the requested vehicle deceleration can only be brought about partially by means of the at least one electric motor operated in its recuperative mode, the electronic device 16a will be in its differential pressure control mode. The electronic device 16a, in its differential pressure mode, is designed and/or programmed to define a target differential pressure for the first wheel brake cylinders 10 and the second wheel brake cylinders 12. The target differential pressure that can be defined by means of the electronic device 16a in its differential pressure control mode is defined as the difference between a first target brake pressure or actual brake pressure and a second target brake pressure. The first target brake pressure is to be understood as a pressure to be set in the first wheel brake cylinders 10, which can either be specified to the electronic device 16a or defined by the electronic device 16a. The first actual brake pressure, which can be used alternatively to the first target brake pressure for determining the target differential pressure, is a measured or estimated first actual brake pressure in the first wheel brake cylinders 10. For example, a pressure sensor 48 connected to one of the brake circuits 14a and 14b can output to the electronic device 16a a pressure sensor signal 50 corresponding to the first actual brake pressure. The second target brake pressure is a pressure to be set in the second wheel brake cylinders 12, which pressure can also be specified to the electronic device 16a or defined by the electronic device 16a. For example, the information signal output by the motor controller to the electronic device 16a can include the first target brake pressure and/or the second target brake pressure. An advantageous possibility for defining the first target brake pressure and/or the second target brake pressure by the electronic device 16a is discussed below.

The electronic device 16a in its differential pressure control mode is furthermore designed and/or programmed to output a current signal 52 to the at least one second wheel inlet valve 22, taking into account the defined target differential pressure, so that the at least one second wheel inlet valve 22 can be/is controlled by means of the output current signal 52. In addition, the electronic device 16a in its differential pressure control mode is designed and/or programmed to define a target current strength of the current signal 52 taking into account the specified target differential pressure. For this purpose, the target current strength of the current signal 52 or an initial value of the target current strength can be/is selected from a set of values having at least three current strength values by means of the electronic device 16a in its differential pressure control mode, taking into account the specified target differential pressure. The electronic device 16a in its differential pressure control mode then outputs the current signal 52 to the at least one second wheel inlet valve 22 with an (actual) current strength corresponding to the defined target current strength.

Due to the advantageous design/programming of the electronic device 16a described in the preceding paragraphs, the control device 16, or the recuperative brake system interacting therewith, brings about the advantages, as explained with reference to the following figures. The electronic device 16a of the control device 16 can in particular be designed/programmed to carry out the processes/method steps explained below. With regard to further advantageous properties of the control device 16, or of the recuperative brake system interacting therewith, reference is therefore made to the following explanations.

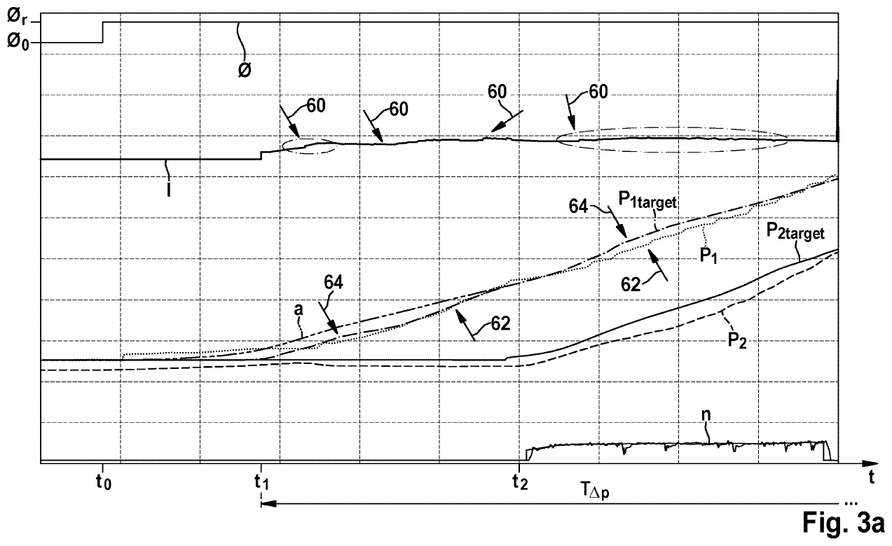

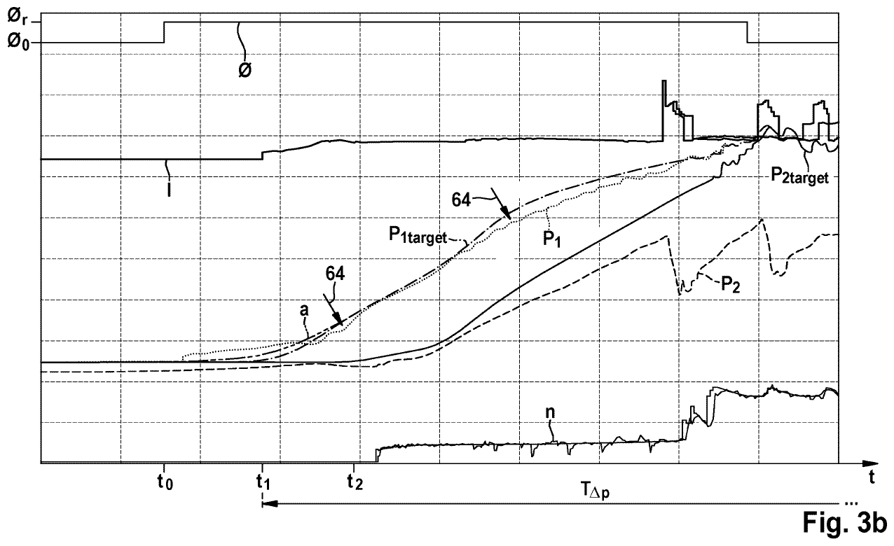

FIGS. 3A and 3B show coordinate systems for explaining an embodiment of the method for operating a recuperative brake system of a vehicle. An abscissa of the coordinate systems of FIGS. 3A and 3B is the time axis t.

The method described below is carried out, merely by way of example, by means of the recuperative brake system explained above. However, it is to be noted that the practicability of the method is not limited to such a brake system type. Instead, the method can be carried out with (nearly) any type of brake system which comprises at least the first wheel brake cylinders 10 assigned to the first axle of the vehicle, the second wheel brake cylinders 12 assigned to the second axle of the vehicle, the at least one first wheel inlet valve 18 upstream of the first wheel brake cylinders 10, the at least one first wheel outlet valve 20 arranged downstream of the first wheel brake cylinders 10, the at least one second wheel inlet valve 22 arranged upstream of the second wheel brake cylinders 12, and the at least one second wheel outlet valve 24 arranged downstream of the second wheel brake cylinders 12. Likewise, the practicability of the method is not limited to any specific type of the vehicle/motor vehicle equipped with the corresponding brake system.

In a first braking process shown schematically by means of FIG. 3A, starting from a time t0 a vehicle deceleration a, not equal to zero, of the vehicle equipped with the recuperative brake system explained above is requested. The vehicle deceleration a not equal to zero can be requested, for example, by a driver of the vehicle via actuation of the brake actuating element 28 of the brake system, or by the vehicle's automatic speed control system. As soon as a vehicle deceleration a not equal to zero is requested, the method described here ascertains whether the requested vehicle deceleration a can be only partially realized by means of the at least one electric motor of the brake system/vehicle operated in its recuperative mode Φᵣ. In addition, starting from time t0 an operating state Φ of the at least one electric motor is switched from its inactive mode Φ₀ to its recuperative mode Φᵣ.

In the first braking process explained here, the requested vehicle deceleration a between the times t0 and t1 is so low that it can be achieved exclusively by means of the at least one electric motor operated in its recuperative mode Φᵣ. For this reason, in order to achieve the highest possible recuperation efficiency during the first braking process, between times t0 and t1 the first target braking pressure p_{1target} to be set in the first wheel brake cylinders 10 and the second target braking pressure p_{2target} to be set in the second wheel brake cylinders 12 are (almost) equal to zero, or are less than or equal to a response pressure of the corresponding wheel brake cylinder 10 or 12. In addition, between the times t0 and t1, the at least one first wheel inlet valve 18 arranged upstream of the first wheel brake cylinders 10, the at least one first wheel outlet valve 20 arranged downstream of the first wheel brake cylinders 10, the at least one second wheel inlet valve 22 arranged upstream of the second wheel brake cylinders 12, and the at least one second wheel outlet valve 24 arranged downstream of the second wheel brake cylinders 12 are controlled in such a way that a build-up of brake pressure in the first wheel brake cylinders 10 and in the second wheel brake cylinders 12 is (substantially) prevented, and therefore the first brake pressure p₁ (probably) present in the first wheel brake cylinders 10 and the second brake pressure p₂ (probably) present in the second wheel brake cylinders 12 are less than or equal to the response pressure of the corresponding wheel brake cylinder 10 or 12. For this purpose, the at least one first wheel outlet valve 20 downstream of the first wheel brake cylinders 10 and the at least one second wheel outlet valve 24 downstream of the second wheel brake cylinders 12 can be switched to their open state between the times t0 and t1, which however is not shown in the coordinate system of FIG. 3A. The at least one first wheel inlet valve 18 upstream of the first wheel brake cylinders 10 can also be switched into its open state between the times t0 and t1. As can be seen from the coordinate system of FIG. 3A, the at least one second wheel inlet valve 22 upstream of the second wheel brake cylinders 12 is controlled into its open state between the times t0 and t1 by means of the current signal 52, wherein due to the design of the at least one second wheel inlet valve 22 (generally) as a valve that is open when currentless, a current strength I of the current signal 52 is equal to zero between the times t0 and t1.

In the first braking process shown in FIG. 3A, the requested vehicle deceleration a from time t1 is so high that the vehicle deceleration a can only be partially realized by means of the at least one electric motor operated in its recuperative mode Φᵣ. For this reason, during a subsequent time interval T_{Δp} a differential pressure control (Δp control) described below is carried out in the first wheel brake cylinders 10 and in the second wheel brake cylinders 12 of the brake system:

In a first sub-step of the differential pressure control carried out during the time interval TA, a target differential pressure Δp_{target} is defined for the first wheel brake cylinders 10 and the second wheel brake cylinders 12. To define the target differential pressure Δp_{target}, the first target brake pressure p_{1target} to be set in the first wheel brake cylinders 10 and the second target brake pressure p_{2target} to be set in the second wheel brake cylinders 12 can be defined continuously in such a way that, given reliable maintenance of the target brake pressures p_{1target} and p_{2target} in the wheel brake cylinders 10 and 12 of the brake system, the requested vehicle deceleration a would with a high probability be brought about by means of the at least one electric motor operated in its recuperative mode Φᵣ, by means of the first brake pressure p₁ in the first wheel brake cylinders 10, and by means of the second brake pressure p₂ in the second wheel brake cylinders 12.

Preferably, if during the differential pressure control a first target braking pressure p_{1target} can be realized in the first wheel brake cylinders 10 (by the corresponding first braking pressure p₁ in the first wheel brake cylinders 10), at which pressure the vehicle deceleration a can be brought about/is brought about by means of a motor braking torque exerted on the vehicle by the at least one electric motor operated in its recuperative mode Φᵣ and by means of the first wheel brake cylinders 10, then the second target brake pressure p_{2target} to be set in the second wheel brake cylinders 12 is defined equal to zero. If the requested vehicle deceleration a can (with a high probability) be achieved only by means of the at least one electric motor operated in its recuperative mode Φᵣ and by means of the first wheel brake cylinders 10, then braking of the second axle of the vehicle by means of the second wheel brake cylinders 12 can be dispensed with. Otherwise, i.e. if the motor braking torque effected by the at least one electric motor operated in its recuperative mode Φᵣ and the first wheel brake cylinders 10 is no longer sufficient to effect the requested vehicle deceleration a, then both the first target braking pressure P_{1target} and the second target braking pressure p_{2target} can be defined to be not equal to zero, wherein the second target braking pressure p_{2target} is generally specified to be less than or equal to the first target braking pressure p_{1target}. In particular, in this case the second target braking pressure p_{2target} can be defined taking into account the requested vehicle deceleration a, the motor braking torque of the at least one electric motor, and the first target braking pressure P_{1target}.

A difference between the first target braking pressure p_{1target} or the first actual braking pressure p₁ and the second target braking pressure p_{2target} is then determined as the target differential pressure Δp_{target}. The target differential pressure Δp_{target} is thus defined according to equation (Eq. 1) or equation (Eq. 2) where:

$$Δ {p}_{target} = {p}_{1 target} - {p}_{2 target} \qquad ( Eq . 1 )$$

$$Δ {p}_{target} = {p}_{1} - {p}_{2 target} \qquad ( Eq . 1 )$$

The first actual brake pressure p₁ can be understood as a measured or estimated pressure value which (with a high probability) prevails in the first wheel brake cylinders 10.

In a further sub-step, a target current strength of the current signal 52 output to the at least one second wheel inlet valve 22 is defined. The target current strength of the current signal 52 is defined taking into account the previously defined target differential pressure Δp_{target}. For this purpose, the target current strength of the current signal 52 or an initial value of the target current strength is selected from a set of values having at least three current strength values, taking into account the specified target differential pressure Δp_{target}. This can also be described as a “smooth Δp control” by means of continuous control of the target current of the current signal 52 using the specified target differential pressure Δp_{target}.

In a further sub-step, the at least one second wheel inlet valve 22 is controlled by means of the current signal 52 output to the at least one second wheel inlet valve 22, wherein an (actual) current strength I of the output current signal 52 (substantially) corresponds to the defined target current strength. In the differential pressure control described here, the at least one second wheel inlet valve 22 is thus controlled during the time interval T_{Δp}, taking into account the defined target differential pressure Δp_{target}. In this way, as indicated by the arrows 60 in the coordinate system of FIG. 3A, a “smooth” control/switching of the at least one second wheel inlet valve 22 is obtained. With the “continuous” pressure build-up in the first wheel brake cylinders 10 marked by the arrows 62 in the coordinate system of FIG. 3A, there is no “wavelike” increase in pressure, as in the related art described above. The arrows 64 in the coordinate system of FIG. 3A also indicate that there occur only relatively small deviations of the first actual brake pressure p₁ in the first wheel brake cylinders 10 from the first target brake pressure p_{1target} to be set simultaneously in the first wheel brake cylinders 10.

Preferably, the target current strength of the current signal 52 or the initial value of the target current strength is determined according to a specified continuous function with the set of values having the at least three current strength values, depending on the defined target differential pressure Δp_{target}. This is easy to carry out. Preferably, the continuous function has a set of values with at least four current strength values. The set of values of the continuous function can in particular have more than four current strength values. The values of the continuous function that result in dependence on the defined target differential pressure Δp_{target} can also be proportional to the target differential pressure Δp_{target}. Alternatively, the target current strength of the current signal 52 or the initial value of the target current strength can be determined according to a specified step function with at least three steps, preferably with at least four steps, in particular with more than four steps, dependent on the defined target differential pressure Δp_{target}.

The initial value of the target current strength can be understood as a value which is then taken into account in defining the target current strength. For example, during the differential pressure control performed during the time interval T_{Δp} at least one further variable can be determined which is also taken into account when defining the target current strength, taking the initial value into account. In particular, during a specified comparison time interval a deviation of the at least one measured or estimated first actual brake pressure p₁ in the first wheel brake cylinders 10 from the first target brake pressure p_{1target} to be set simultaneously in each of the first wheel brake cylinders 10 can be determined. An offset value for the target current strength of the current signal 52 can then be defined taking into account the determined deviation. In this case, the target current strength of the current signal 52 can be defined as the sum of the initial value of the target current strength and the offset value. By determining the target current strength as described here, component tolerances and/or aging effects in the brake system can be advantageously compensated for.

As an optional further development, during the differential pressure control carried out in the time interval T_{Δp} a period of time can be (continuously) determined during which the at least one measured or estimated first actual brake pressure p₁ in the first wheel brake cylinders 10 deviates by at least a specified minimum pressure deviation from the corresponding first target brake pressure p_{1target} to be set simultaneously in the first wheel brake cylinders 10. If the determined time period exceeds a specified time threshold value, the target current strength of the current signal 52 is preferably defined for a specified or defined closing time such that the at least one second wheel inlet valve 22 is switched to its closed state by means of the current signal 52 output thereto for the specified or defined closing time. In this way, the occurrence of larger deviations of the first actual brake pressure p₁ in the first wheel brake cylinders 10 from the first target brake pressure P_{1target} to be set simultaneously in the first wheel brake cylinders 10 over a time exceeding the time threshold can be prevented.

Preferably, at the beginning of the differential pressure control executed during the time interval TA the target differential pressure Δp_{target} is defined according to equation (Eq. 1), i.e. as the difference between the specified or defined first target brake pressure p_{1target} to be set in the first wheel brake cylinders 10 and the specified or defined second target brake pressure p_{2target} to be set in the second wheel brake cylinders 12.

In the first braking process shown schematically in FIG. 3A, the requested vehicle deceleration a between the times t1 and t2 can be brought about by means of the at least one electric motor operated in its recuperative mode Φᵣ and by means of the first wheel brake cylinder 10 assigned to the first axle of the vehicle. For this reason, the first wheel outlet valves 20 downstream of the first wheel brake cylinders 10 are kept closed from time t1, while the second wheel outlet valves 24 downstream of the second wheel brake cylinders 12 continue to be controlled in their open state between times t1 and t2. The differential pressure control is then carried out between times t1 and t2 as explained above.

Starting from time t2, the requested vehicle deceleration a can only be carried out by means of the at least one electric motor operated in its recuperative mode Φᵣ, by means of the first wheel brake cylinder 10, and by means of the second wheel brake cylinder 12 assigned to the second axle of the vehicle. For this reason, the second wheel outlet valves 24 downstream of the second wheel brake cylinders 12 are kept closed from time t2 (like the first wheel outlet valves 20 downstream of the first wheel brake cylinders 10). In addition, by means of a non-zero pump speed n of at least one pump 36 of the brake system, brake fluid can be pumped into the brake system from at least one reservoir 34 downstream of the first wheel outlet valves 20 and the second wheel outlet valves 24. In contrast to the related art described above, however, the pressure build-up in the second wheel brake cylinders 12 starting from time t2 causes (almost) no pressure drop in the first wheel brake cylinders 10.

In a second braking process, shown in the coordinate system in FIG. 3B, a vehicle deceleration a not equal to zero starting at time t0 is also requested, but this deceleration can here still be achieved between times t0 and t1 by means of the electric motor operated in its recuperative mode Φᵣ. Compared to the first braking process, however, a significantly faster braking of the vehicle is required. During the second braking process, the vehicle deceleration a not equal to zero requested between times t0 and t1 can also only be achieved by means of the electric motor operated in its recuperative mode Φᵣ and by means of the first wheel brake cylinders 10 of the first axle and, from time t2, only by means of the at least one electric motor operated in its recuperative mode or, by means of the first wheel brake cylinders 10, and by means of the second wheel brake cylinders 12 of the second axle. The first target brake pressure p_{1target} to be set in the first wheel brake cylinders 10 and the second target brake pressure p_{2target} to be set in the second wheel brake cylinders 12 are defined accordingly.

However, if it is ascertained during the differential pressure control that the measured or estimated first actual brake pressure p₁ in the first wheel brake cylinders 10 is becoming lower than the first target brake pressure P_{1target} to be set simultaneously in the first wheel brake cylinders 10 by at least a specified limit deviation, the target differential pressure Δp_{target} will preferably be defined for a specified or defined transition time in accordance with equation (Eq. 2), i.e. as the difference between the measured or estimated first actual braking pressure p₁ in the first wheel brake cylinders 10 and the second target brake pressure p_{2target} to be set in the second wheel brake cylinders 12. The occurrence of a deviation, past the limit deviation, of the second actual brake pressure p₂ in the second wheel brake cylinders 12 from the second target brake pressure p_{2target} to be set simultaneously in the second wheel brake cylinders 12 can thus reliably be prevented.

To set the first actual brake pressure p₁ in the first wheel brake cylinders 10 and the second actual brake pressure p₂ present in the second wheel brake cylinders 12, the target differential pressure Δp_{target} is again set/regulated during the time interval Top by means of the differential pressure control explained above. For this purpose, in the second braking process of FIG. 3B as well the target current strength of the current signal 52 or an initial value of the target current strength is selected from a set of values having at least three current strength values, taking into account the specified target differential pressure Δp_{target}. The arrows 64 in the coordinate system of FIG. 3B again indicate that there occur only relatively small deviations of the first actual brake pressure p₁ in the first wheel brake cylinders 10 from the first target brake pressure p_{1target} to be set simultaneously in the first wheel brake cylinders 10. In contrast to the related art described above, no “soft” brake actuating element 28 therefore occurs during the differential pressure control executed in the time interval T_{Δp}.

It is expressly pointed out that the differential pressure control executed during both braking processes dispenses with an alternation between a provision of overcurrent to the at least one second wheel inlet valve 22 and of undercurrent to the at least one second wheel inlet valve 22. This is not required due to the defining of the target current strength of the current signal 52 or of the initial value of the target current strength from the set of values having the at least three current strength values, taking into account the defined target differential pressure Δp_{target}.

1-12. (canceled)

13. A control device for a recuperative brake system of a vehicle, comprising:
an electronic device configured to query or ascertain whether a requested vehicle deceleration can only partially be brought using at least one electric motor of the brake system or of the vehicle operated in its recuperative mode, and which may be in a differential pressure control mode, in which:
a target differential pressure for first wheel brake cylinders of the brake system, which are assigned to a first axle of the vehicle, and second wheel brake cylinders of the brake system, which are assigned to a second axle of the vehicle, can be defined as a difference between:
a specified or defined first target brake pressure to be set in the first wheel brake cylinders or a measured or estimated first actual brake pressure in the first wheel brake cylinders, and
a specified or defined second target brake pressure to be set in the second wheel brake cylinders, and
taking into account the defined target differential pressure, a current signal can be output to at least one wheel inlet valve of the brake system upstream of the second wheel brake cylinders, so that the at least one wheel inlet valve can be controlled using the output current signal;
wherein the electronic device in the differential pressure control mode is additionally configured to define a target current strength of the current signal taking into account the defined target differential pressure, in that the target current strength of the current signal or an initial value of the target current strength, is selected using the electronic device, taking into account the defined target differential pressure from a set of values having at least three current strength values.

14. The control device according to claim 13, wherein the electronic device in the differential pressure control mode is configured to define the target current strength of the current signal or the initial value of the target current strength according to a specified continuous function with the set of values having the at least three current strength values, depending on the defined target differential pressure.

15. The control device according to claim 13, wherein the electronic device is configured to, after a start of its differential pressure control mode, define an offset value for the target current strength of the current signal and define the target current strength of the current signal as a sum of the initial value of the target current strength and the offset value, taking into account a deviation in each case of the at least one first actual brake pressure measured or estimated during a specified comparison time interval in the first wheel brake cylinders from the corresponding first target brake pressure to be set simultaneously in the first wheel brake cylinders.

16. The control device according to claim 13, wherein the electronic device is configured to, after a start of the differential pressure control mode, determine a time period during which the at least one measured or estimated first actual brake pressure in the first wheel brake cylinders deviates by at least a specified minimum pressure deviation from the first target brake pressure to be set simultaneously in the first wheel brake cylinders in each case, and, if the determined time period exceeds a specified time threshold value, define the target current strength of the current signal for a specified or defined closing time such that the at least one wheel inlet valve is switched to a closed state using the current signal output thereto for the specified or defined closing time.

17. The control device according to claim 15, wherein the electronic device is configured to, at a beginning of the differential pressure control mode, define the target differential pressure as the difference between the specified or defined first target brake pressure to be set in the first wheel brake cylinders and the specified or defined second target brake pressure to be set in the second wheel brake cylinders, but wherein, if the measured or estimated first actual brake pressure in the first wheel brake cylinders is less than the first target brake pressure to be set simultaneously in the first wheel brake cylinders by at least one specified limit deviation, the electronic device is configured to define, for a specified or defined transition time, the target differential pressure as the difference between the measured or estimated first actual brake pressure in the first wheel brake cylinders and the second target brake pressure to be set in the second wheel brake cylinders.

18. A recuperative brake system for a vehicle, comprising:
a control device including:
an electronic device configured to query or ascertain whether a requested vehicle deceleration can only partially be brought using at least one electric motor of the brake system or of the vehicle operated in its recuperative mode, and which may be in a differential pressure control mode, in which:
a target differential pressure for first wheel brake cylinders of the brake system, which are assigned to a first axle of the vehicle, and second wheel brake cylinders of the brake system, which are assigned to a second axle of the vehicle, can be defined as a difference between:
a specified or defined first target brake pressure to be set in the first wheel brake cylinders or a measured or estimated first actual brake pressure in the first wheel brake cylinders, and
a specified or defined second target brake pressure to be set in the second wheel brake cylinders, and
taking into account the defined target differential pressure, a current signal can be output to at least one wheel inlet valve of the brake system upstream of the second wheel brake cylinders, so that the at least one wheel inlet valve can be controlled using the output current signal;
wherein the electronic device in the differential pressure control mode is additionally configured to define a target current strength of the current signal taking into account the defined target differential pressure, in that the target current strength of the current signal or an initial value of the target current strength, is selected using the electronic device, taking into account the defined target differential pressure from a set of values having at least three current strength values;
the first wheel brake cylinders, which are assigned to the first axle of the vehicle;
the second wheel brake cylinders, which are assigned to the second axle of the vehicle; and
the at least one wheel inlet valve upstream of the second wheel brake cylinders.

19. A method for operating a recuperative brake system of a vehicle, comprising the following steps:
ascertaining whether a vehicle deceleration requested by a driver of the vehicle and/or an automatic speed control system of the vehicle is only partially realizable using at least one electric motor of the brake system or of the vehicle operated in a recuperative mode; and
when the vehicle deceleration can only be partially realized using the at least one electric motor, carrying out a differential pressure control in wheel brake cylinders of the brake system, including the following sub-steps:
defining a target differential pressure for first wheel brake cylinders of the brake system, which are assigned to a first axle of the vehicle, and second wheel brake cylinders of the brake system, which are assigned to a second axle of the vehicle, wherein a difference between
a specified or defined first target brake pressure to be set in the first wheel brake cylinders or a measured or estimated first actual brake pressure in the first wheel brake cylinders, and
a specified or defined second target brake pressure to be set in the second wheel brake cylinders,
is defined as the target differential pressure; and
controlling at least one wheel inlet valve of the brake system upstream of the second wheel brake cylinders using a current signal output to the at least one wheel inlet valve taking into account the defined target differential pressure;
defining a target current strength of the current signal taking into account the defined target differential pressure by selecting the target current strength of the current signal r an initial value of the target current strength from a set of values having at least three current strength values, taking into account the defined target differential pressure.

20. The method according to claim 19, wherein the target current strength of the current signal or the initial value of the target current strength is defined according to a specified continuous function with the set of values having the at least three current strength values, depending on the defined target differential pressure.

21. The method according to claim 19, wherein during the differential pressure control, taking into account a deviation in each case of the at least one first actual brake pressure measured or estimated during a specified comparison time interval in the first wheel brake cylinders from the first target brake pressure to be set simultaneously in the first wheel brake cylinders, an offset value for the target current strength of the current signal is defined, and the target current strength of the current signal is defined as a sum of the initial value of the target current strength and the offset value.

22. The method according to claim 19, wherein, during the differential pressure control, a time period is determined during which the at least one first actual brake pressure measured or estimated in the first wheel brake cylinders deviates by at least a specified minimum pressure deviation from the first target brake pressure to be set simultaneously in the first wheel brake cylinders, and, when the determined time period exceeds a specified time threshold value, the target current strength of the current signal is defined, for a specified or defined closing time, such that the at least one wheel inlet valve is switched to a closed state using the current signal output thereto for the specified or defined closing time.

23. The method according to claim 19, wherein, at a beginning of the differential pressure control, the target differential pressure is defined as the difference between the specified or defined first target brake pressure to be set in the first wheel brake cylinders and the specified or defined second target brake pressure to be set in the second wheel brake cylinders, but wherein, when the measured or estimated first actual brake pressure in the first wheel brake cylinders becomes lower than the first target brake pressure to be set simultaneously in the first wheel brake cylinders by at least one specified limit deviation, then the target differential pressure is defined for a specified or defined transition time as the difference between the measured or estimated first actual brake pressure in the first wheel brake cylinders and the second target brake pressure to be set in the second wheel brake cylinders.

24. The method according to claim 19, wherein, when a first target braking pressure is realizable in the first wheel brake cylinders during the differential pressure control, at which pressure the vehicle deceleration is realizable using a motor braking torque applied to the vehicle using the at least one electric motor operated in its recuperative mode and using the first wheel brake cylinders, then the second target braking pressure to be set in the second wheel brake cylinders is defined to be equal to zero, and otherwise the second target braking pressure is defined taking into account the vehicle deceleration, the motor braking torque, and the first target braking pressure.
